(19) United States
(12) Patent Application Publication
(10) Pub. No.: US 2009/0038460 A1
(43) Pub. Date: Feb. 12, 2009

(54) ARC-CUTTING GUIDE FOR A PORTABLE POWERED HAND TOOL

(75) Inventors: Steven Sze Chun Fong, Hong Kong SAR (CN); Ping Hay Heun, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: CHOON NANG ELECTRICAL APPLIANCE MFY., LIMITED, Hong Kong (CN)

(21) Appl. No.: 11/834,179

(22) Filed: Aug. 6, 2007

(51) Int. Cl. B26D 7/00; B23Q 27/00

(52) U.S. Cl. 83/522.25; 409/179

(57) ABSTRACT

A swing arm has a fixture at one end for mounting a hand tool, and a longitudinally-extending channel including a slot. An elongate slider member is engaged in the channel, and includes a point offset longitudinally from center of the slider member for engagement with a workpiece to define a center about which the swing arm is rotated. A fastener having a head and threaded shank is retained in a recess such that the shank extends through the slot. A threaded knob is engaged with the shank for clamping the slider member in position, and a handle connected to and captively retained with the knob is free to rotate about a handle axis.

### TECHNICAL FIELD

The present invention relates to an arc-cutting guide for forming circular and arcuate cuts in a workpiece with a powered hand tool, such as a rotary cutting tool.

### BACKGROUND OF THE INVENTION

Craftsmen, as well as hobbyists, commonly have a need to cut out large circular or arcuate pieces of wood, carpet and tile, or the like, to make many different products. Numerous arc-cutting guides have been used for guiding cutters for such work. Most of these devices consist of a swing arm with a cutting tool holder of some kind, a point or means for defining a pivot, and possibly a measuring device. By attaching a rotary cutter to a swing arm of known length which is then anchored at a pivot point on a workpiece, the cutter can be moved along a circumferential path to shape the workpiece to the desired radius.

U.S. Pat. No. 6,752,572 describes an arc-cutting guide comprising a swing arm defining a longitudinally extending channel and a slot. A fixture at one end of the arm is provided for mounting a powered hand tool. An elongate slider member has a point at one longitudinal end and is received in the channel. The slider member has a threaded aperture for engaging a threaded end of a knob, the end of the knob also being received in the slot, allowing it to be clamped at different positions to the arm for varying the radius By turning the slider member end-for-end two ranges of radii are defined, the arm being correspondingly marked with two measuring scales. A handle is fixed to the end of the arm and is grasped and may be used to exert pressure to hold the point in the desired position in the surface being cut. The shortcomings in this prior art device include its complexity and number of parts inherent in the design, which tend to increase its cost. Moreover, for a number of reasons, it is difficult to use. The positioning of the clamping knob adjacent to the handle tends to obstruct the path traced by the user's hand and lower arm when tracing a circle. With the handle fixed to the arm, the user cannot maintain a fixed grip on the handle, but must allow it to rotate in his hand as the arm is rotated in use. The handle position cannot be varied and the small knob and sliding member being small separate parts can be easily misplaced. The presence of the two measuring scales on the arm, one on either side of the mark read against the scales can provide confusion as to which scale is the correct one. It is an object of the present invention to overcome or substantially ameliorate the above disadvantages or more generally to provide an improved arc-cutting guide for portable powered hand tools.

### DISCLOSURE OF THE INVENTION

According to one aspect of the present invention there is provided an arc-cutting guide for a portable powered hand tool, the guide comprising:

a swing arm defining a longitudinally extending channel;

a longitudinally extending slot in the channel;

a fixture at one end of the swing arm for mounting the hand tool;

an elongate slider member engaged in the channel, the slider member including a recess;

a point offset longitudinally from a centre of the slider member for engagement with a workpiece to define a centre about which the swing arm is rotated;

a fastener extending through the slot, the fastener having a head received in the recess;

a threaded knob engaged and held captive with the fastener, whereby tightening the knob clamps the swing arm between the knob and the slider member, and

a handle projecting outwardly from the knob, the handle being captively retained with the knob and free to rotate about a handle axis.

In another aspect the invention provides an arc-cutting guide for a portable powered hand tool, the guide comprising:

a swing arm defining a longitudinally-extending channel;

a longitudinally extending slot in the channel;

a fixture at one end of the swing arm for mounting the hand tool;

an elongate slider member engaged in the channel, the slider member including a longitudinally-extending recess;

a point offset longitudinally from a centre of the slider member for engagement with a workpiece to define a centre about which the swing arm is rotated;

a fastener having a head and threaded shank, the head being retained in the recess and the shank extending through the slot;

a threaded knob engaged with the shank, whereby tightening the knob clamps the swing arm between the knob and the slider member, and

a handle projecting outwardly from the knob, the handle being captively retained with the knob and free to rotate about a handle axis.

Preferably the slider member includes a longitudinally-extending rib received in the channel with a longitudinally-extending flange on either transverse side of the rib, each flange being provided with respective measuring indicia to be read against a measuring mark on one transverse side of the swing arm. The swing arm and rib thus provide a physical and visual separation between the scales, allowing ready accurate measurements to be made with the slider in either orientation.

This invention thus provides an arc-cutting guide which is effective and efficient in operational use. By making both the knob and handle captively retained they cannot ordinarily become separated from the guide. Mounting both knob and handle by a single fastener not only allows the tool to the be economically constructed but also allows simple one-handed operation of both, while a firm grip can be retained on the handle as the guide is rotated.

### BRIEF DESCRIPTION OF THE DRAWINGS

Preferred forms of the present invention will now be described by way of example with reference to the accompanying drawings, wherein:

FIG. 1 is a pictorial view of the arc-cutting guide of the invention, with the slider member in a first use orientation;

FIG. 2 is a part cross-sectioned end view of the handle assembly of the arc-cutting guide of FIG. 1 and

FIG. 3 is a pictorial view of the arc-cutting guide of FIG. 1, with the slider member in a released position;

FIG. 4 is a pictorial view of the arc-cutting guide of FIG. 1, with the slider member in a second use orientation;

### DESCRIPTION OF THE PREFERRED EMBODIMENTS

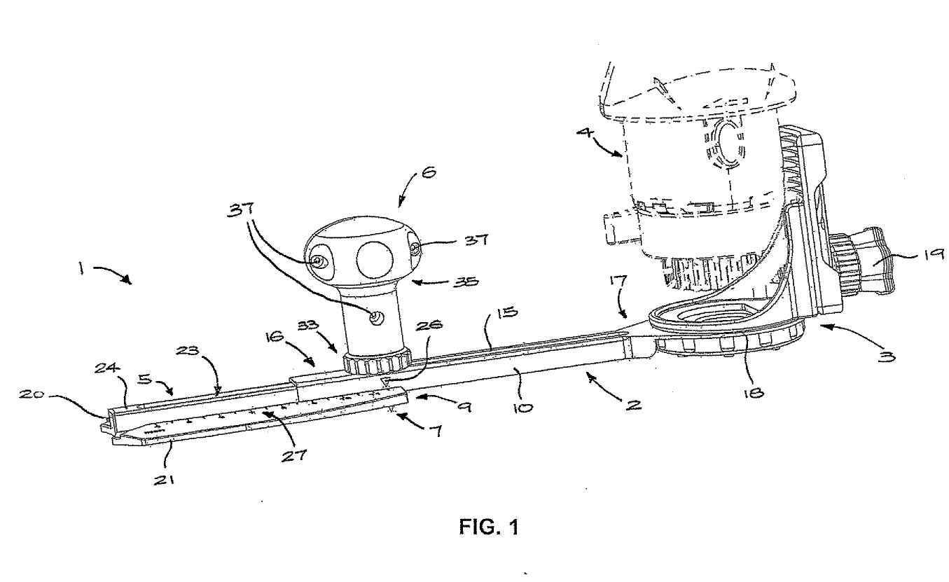

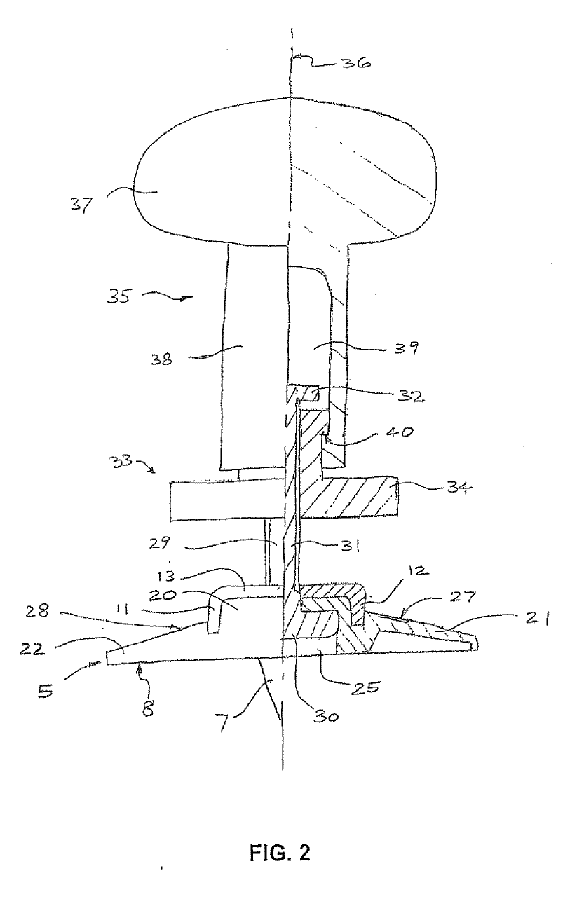

Referring to the drawings, particularly FIGS. 1 and 2, an arc-cutting guide 1 includes an elongate a swing arm 2 with a fixture 3 at one end for mounting a hand tool, such as the rotary electric cutting tool 4 (shown in dashed outline in FIG. 1). A slider member 5 is telescopically engaged with the swing arm 2 and connected thereto by the handle assembly 6. A point 7 projects from a planar lower face 8 of the slider member 5. The point 7 is offset longitudinally as far as possible from a centre of the slider member, being positioned adjacent to a first end 9 of the slider member 5.

The swing arm 2 includes a bar portion 10 having a U-shaped section comprising parallel flanges 11, 12 joined by a web 13 to define an inverted channel 14. A longitudinal slot 15 is formed centrally in the web 13, extending from first to a second end 16, 17 of the bar portion 10. At the second end 17 a ring portion 18 is formed integrally with the bar portion 10. The fixture 3 is mounted on the ring portion 18, and includes a fastener 19 for engaging the tool 4. A measuring mark 26 is provided on an outer face of the flange 12.

The slider member 5 includes an elongate rib 20 with flanges 21, 22 on either transverse side thereof. The rib 20 is received in the channel 14, with the flanges 21, 22 projecting from either side of the arm 2. A recess extends longitudinally in the rib 20, a narrow mouth portion 23 of the recess opens through the upper face 24 of the rib and extends to a broader throat portion 25. Measuring scales 27 and 28 are provided on the flanges 21, 22 respectively

A fastener 29 has a head 30 and a narrower externally threaded shank 31. The head 30 is retained in the throat portion 25 of the recess and the shank 31 extending through the mouth portion 23 of the recess, and through the slot 15, such that the fastener 29 is free to slide longitudinally relative to both the arm 2 and slider member 5. At the end opposing the head 30, a collar 32 is fixed to the fastener 29.

A knob 33 includes a crenellated ring portion 34 by which it may be grasped and an internal screw thread engaged with the threaded shank 29, whereby tightening the knob 33 clamps the slider member 5 to the swing arm 2. The collar 32 retains the knob 33 in threaded engagement with the fastener 29.

Mounted coaxially with the fastener 29 and knob 33, a handle 35 projects outwardly from the knob 33. The handle 35 includes two halves joined at the axis 36 by fasteners 37, each including a bulbous grip 37 and a shaft 38 in which an open-ended cavity 39 is formed to receive the knob 33 and allow free rotation of the handle 35 relative to the knob about the axis 36. The handle 35 and knob 33 include cooperating faces 40 for captively retaining the handle and knob together.

As seen in FIG. 1, with the slider member 5 received in the arm 2 in a first orientation such the point 7 is innermost, a desired radius of cut can be obtained by moving the slider member 5 and reading the scale 27 against the mark 26, before tightening the knob. Grasping the handle 3 with one hand, the point 7 can be held in engagement with a workpiece (not shown) to define a centre about which the swing arm 2 is then rotated while the tool 4 is moved by the other hand to cut the arc. When the slider member 5 is moved from the (outermost) position shown in FIG. 1 toward the fixture 3 to reduce the radius of cut, the longitudinal position of the handle can also be varied to suit the user, independently of the desired radius to be cut.

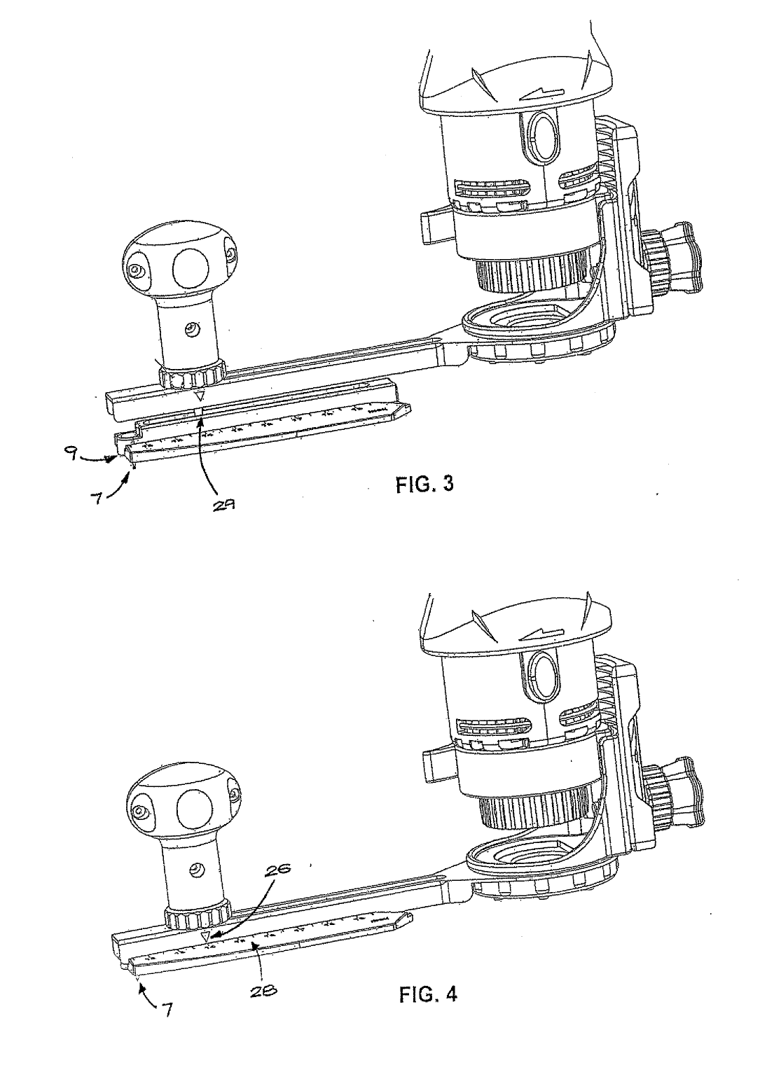

By releasing the knob 33, the rib 20 drops out of the channel 14, allowing the slider member 5 to be rotated about the fastener 29 through half a turn, for instance to the position shown in FIG. 3. As seen in FIG. 4, tightening the knob 33 pulls the rib 20 back into the channel 14, and in this second orientation the point 7 is outermost, allowing radii of larger dimensions to be measured by reading the scale 28 against the mark 26.

Aspects of the present invention have been described by way of example only and it should be appreciated that modifications and additions may be made thereto without departing from the scope thereof.

1. An arc-cutting guide for a portable powered hand tool the guide comprising:
a swing arm defining a longitudinally extending channel;
a longitudinally extending slot in the channel;
a fixture at one end of the swing arm for mounting the hand tool;
an elongate slider member engaged in the channel, the slider member including a recess;
a point offset longitudinally from a center of the slider member for engagement with a workpiece to define a center about which the swing arm is rotated;
a fastener extending through the slot, the fastener having a head received in the recess;
a threaded knob engaged and held captive with the fastener, tightening of the knob clamping the swing arm between the knob and the slider member, and
a handle projecting outwardly from the knob, the handle being captively retained with the knob and free to rotate about a handle axis.

2. An arc-cutting guide for a portable powered hand tool, the guide comprising:
a swing arm defining a longitudinally-extending channel;
a longitudinally extending slot in the channel;
a fixture at one end of the swing arm for mounting the hand tool;
an elongate slider member engaged in the channel, the slider member including a longitudinally-extending recess;
a point offset longitudinally from a center of the slider member for engagement with a workpiece to define a center about which the swing arm is rotated;
a fastener having a head and a threaded shank, the head being retained in the recess and the shank extending through the slot;
a threaded knob engaged with the shank, tightening the knob clamping the swing arm between the knob and the slider member, and
a handle projecting outwardly from the knob, the handle being captively retained with the knob and free to rotate about a handle axis.

3. The arc-cutting guide of claim 1 wherein the slider member includes a longitudinally-extending rib received in the channel with a respective longitudinally-extending flange one each transverse side of the rib, each flange including respective measuring indicia to be read against a measuring mark on one transverse side of the swing arm.

4. The arc-cutting guide of claim 1 wherein the knob and handle are mounted to rotate about an axis of the fastener.

5. The arc-cutting guide of claim 2 wherein the slider member includes a longitudinally-extending rib received in the channel with a respective longitudinally-extending flange on each transverse side of the rib, each flange including respective measuring indicia to be read against a measuring mark on one transverse side of the swing arm.

6. The arc-cutting guide of claim 2 wherein the knob and handle are mounted to rotate about an axis of the fastener.
